(19) United States
(12) Patent Application Publication
(10) Pub. No.: US 2009/0049127 A1
(43) Pub. Date: Feb. 19, 2009

(54) System and method for invitation targeting in a web-based social network

(76) Inventors: Yun-Fang Juan, Palo Alto, CA (US); Kang-Xing Jin, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/893,797

(22) Filed: Aug. 16, 2007

(51) Int. Cl. G06F 15/16

(52) U.S. Cl. 709/204

(57) ABSTRACT

A system and method for selecting users of a web-based social network who are likely to respond to an invitation, each of the users having associated profile information is disclosed. The method includes selecting pilot users and a reduced set of keywords from the profile information. The method further includes sending the invitation to the pilot users, receiving responses from the pilot users, and classifying the responses as either positive or negative. A training set of vector pairs is created each vector pair representing a pilot user and including data representing a classified response and training keywords selected from the reduced set of keywords and associated profile information for the pilot user. A function is determined based on the vectors and used to calculate a likelihood that each of one or more users of the web based social network will respond to the invitation.

### CROSS-REFERENCE TO RELATED APPLICATIONS

The present application incorporates by reference:

U.S. patent application Ser. No. 11/639,655 filed on Dec. 14, 2006 entitled “Systems and Methods for Social Mapping,” which in turn claims the benefit and priority of U.S. Provisional Patent Application Ser. No. 60/750,844 filed on Dec. 14, 2005 entitled “Systems and Methods for Social Mapping,”

U.S. patent application Ser. No. 11/499,093 filed on Aug. 2, 2006 entitled “Systems and Methods for Dynamically Generating Segmented Community Flyers,”

U.S. patent application Ser. No. 11/503,242 filed on Aug. 11, 2006 entitled “System and Method for Dynamically Providing a News Feed About a User of a Social Network,”

U.S. patent application Ser. No. 11/580,220 filed on Oct. 11, 2006, entitled “System and Method for Tagging Digital Media,”

U.S. patent application Ser. No. ______ filed on Aug. 16, 2007, Attorney Docket No. PA4140US entitled “System and Method for Keyword Selection in a Web-Based Social Network,” and

U.S. Provisional patent application Ser. No. 11/796,184 filed on Apr. 27, 2007 entitled “System and Method for Automatically Giving Gifts and Displaying Assets in a Social Network Environment.”

### BACKGROUND OF THE INVENTION

1. Field of the Invention

The present invention relates generally to social networks, and more particularly to invitations in a social network.

2. Description of Related Art

Social network environments allow users to send many types of invitations to other users. Examples of an invitation include an advertisement, a request to join a group, a request for an information exchange, a survey, a request to write a blog entry, a request to verify a photo tag, and so forth.

An invitation may be personalized or targeted to a particular user in the social network environment. Targeting may include predicting a likelihood that the user will respond to an invitation and presenting the invitation to the user if the likelihood is high. Targeting may also be useful for determining that the user has a low probability of responding to certain invitations because the invitations are not interesting to the user.

There are several approaches to personalizing or targeting an invitation to a particular user. One approach is to track buying patterns. For example, after a customer purchases a book via an internet store, the store may tell the customer about products in stock that the customer might like such as other books by the same author, or books purchased by other people who also bought the book that the customer purchased. This approach, however, is limited to customers who purchase items.

Another approach to targeting is to present invitations to a user who is a member of a particular group. Groups may be based on gender, school, age, residence, club membership, political affiliation, and so on. However, not all groups are well defined within the social network environment and determining that a person is a member of a group may be cumbersome and require skill and an understanding of the group dynamics and common interests. Unfortunately, none of these approaches automatically select users of a social network environment who have an increased probability of responding positively to an invitation.

### SUMMARY OF THE INVENTION

The invention provides a method for selecting users of a web-based social network, each having associated profile information, who are likely to respond to an invitation. In one embodiment, the method generates a probability function that will predict the likelihood of a user in a social network environment responding to an invitation. A pilot group of users is selected, as is a reduced set of keywords based on profiles of the pilot group. The method further includes sending the invitation to the pilot group and creating a training set of vectors based on responses to the invitation, the pilot group profiles, and the reduced set of keywords. The probability function may be determined from the training set and applied to the users in the social network environment to predict which users are more likely to respond to the invitation.

In another embodiment, the method comprises selecting a plurality of pilot users from the users in the web based social network, selecting a reduced set of keywords from the profile information for the pilot users, sending the invitation to the pilot users, and receiving responses to the invitation from the pilot users. The responses are classified as either positive or negative and a training set of vector pairs is created, each vector pair representing a pilot user and including data representing the classified response received from the pilot user and a set of training keywords selected from the reduced set of keywords and based at least in part on the associated profile information for the pilot user. The method further includes determining a function based on the training set of vector pairs that calculates from a user's profile information a likelihood that the user will respond to the invitation and calculating from the function a likelihood that each of one or more of the users in the web based social network will respond to the invitation.

### BRIEF DESCRIPTION OF THE DRAWINGS

FIG. 1 illustrates an exemplary social network that may be used with various embodiments of the invention.

FIG. 2 illustrates one embodiment an architecture of the invitation engine of FIG. 1.

FIG. 3 is screen a shot illustrating an example of an invitation embedded in a news feed for a user.

FIG. 4 is an illustration of an exemplary iPod download invitation according to one embodiment.

FIG. 5 is a flow chart of an exemplary method for selecting target users of a web-based social network.

### DETAILED DESCRIPTION OF THE INVENTION

The present invention provides a method for selecting users in a web-based social network who are likely to respond to an invitation. In one embodiment, the invitation is first sent to a pilot group of users selected at random. Positive and negative responses are recorded. A set of the pilot group profiles containing a reduced set of keywords may be correlated with the positive and negative responses to the invitation and the correlations may be used to determine a probability function that indicates the likelihood of responses based on the profiles. The profiles of other the users in the social network may be analyzed using the probability function, and target users may be selected to receive the invitation based on the likelihood of responding to the invitation.

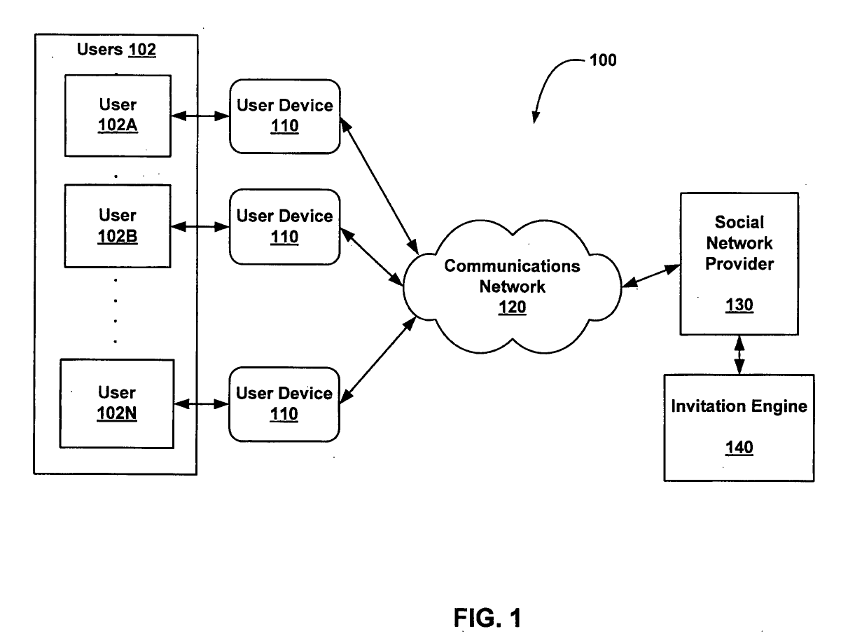

FIG. 1 illustrates an exemplary social network environment 100 that may be used with embodiments of the invention. One or more users 102 at user devices 110, are coupled to a social network provider 130 via a communications network 120. In various embodiments, the user devices 110 may include a computer terminal, a personal digital assistant (PDA), a wireless telephone, a digital camera, a mobile device, a mobile phone, a cell-phone, a smart-phone, a notebook computer, a laptop computer, a hand-held game console, and so forth. The communications network 120 may include a local area network (LAN) such as an intranet, a wide area network (WAN) such as the Internet, a wireless network, etc.

The social network provider 130 is typically a server that provides social networking services, communication services, dating services, company intranets, and/or online games, etc. The social network provider 130 may assemble and store profiles of the users 102 for use in providing the social networking services. In some embodiments, the social network environment 100 includes one or more segmented communities, which are separate, exclusive or semi-exclusive subsets of the social network environment 100, wherein users 102 who are segmented community members may access and interact with other members of their respective segmented community. Examples of such groupings are set forth in further detail in co-pending U.S. patent application Ser. No. 11/369,655, incorporated herein by reference.

The users 102 may include various types of users 102A, 102B . . . 102N, (hereinafter users 102A-102N). For example, a user 102A may be a pilot user who is selected to receive an invitation as a part of the pilot study, while a user 102B is a target user selected to receive the invitation based on a probability function. A probability function is a function that returns a probability that a user 102 will respond positively (or negatively) to the invitation. It may, for example, be based on one or more keywords in the profile of the user 102.

The social network environment 100 further includes an invitation engine 140 coupled to the social network provider 130. The invitation engine 140 is configured to select a group of pilot users 102A for a pilot study, send invitations to the pilot group, determine a probability function based on results of the pilot study, select the target users 102B from the users 102 using the probability function, and send invitations the target users 102B.

Keywords include words or phrases relating to information entered by users and stored in the respective profiles of the users 102A-102N. Keywords may also be words or phrases entered by the social network provider 130 to characterize the users 102A-102N. Keywords may include words relating to demographics, interests, usage, actions, or other information that may describe each of the users 102A-102N. A particular user profile may include multiple occurrences of one or more keywords. The profile information for the users 102A-102N while typically stored with the social network provider may also be found in profile databases in the invitation engine 140.

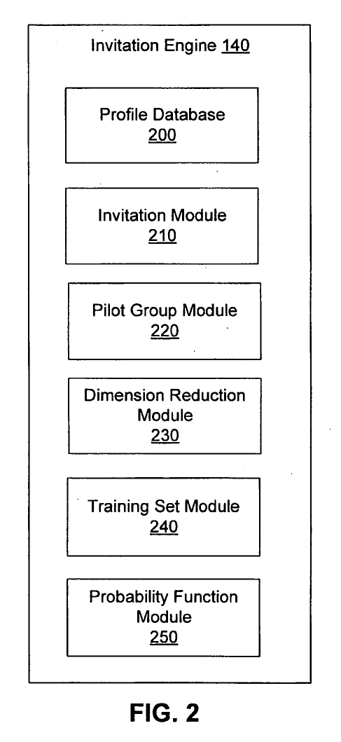

FIG. 2 illustrates one embodiment an architecture of the invitation engine 140 of FIG. 1. As shown, the invitation engine 140 includes a profile database 200, an invitation module 210, a pilot group module 220, a dimension reduction module 230, a training set module 240, and a probability function module 250.

The profile database 200 manages profile information that is provided by users 102 of the social network. As discussed above, the profile information includes keywords relating to demographics, interests, usage, actions, and/or other information that may describe the users 102. The profile database 200 may store values to represent various types of keywords, including numerical values, binary values, and/or categorical values. For example, a numerical value may represent an age or phone number. A binary number may indicate whether a keyword occurs or does not occur in the profile of a user 102. For example, if the keyword is “football,” a “1” may indicate that the word “football” occurs at least once in the profile of the user 102 and a “0” that the word “football” does not occur in the profile of the user 102. In other embodiments, a “1” may indicate that the word “football” occurs more than a predetermined number of times in the profile for the user 102. A categorical value may represent a selection from a list. For example, political views may be categorized as 1=liberal, 2=conservative, 3=independent, etc.

Keywords relating to demographics may include information regarding age, gender, relationship status; home state, and school. Demographic keywords may be represented by numerical values; binary values, and/or categorical values. Keywords relating to interests include book titles, authors, movies, television programs, and music and may be represented by binary values. Examples of keywords relating to usage include information regarding friendships, blog posts, online gifts given and received via the social network provider 130, online purchases via the social network provider 130, photo uploads, photo downloads, photo tags, and photo tag confirmations and may be represented by numerical values, binary values, and/or categorical values.

Table 1 illustrates an example of various keyword names, keyword types, and keyword values that may be stored in the profile database 200. For example, the keyword “Birth Year” in the Keyword Names column of Table 1 is a demographic keyword type and may be represented by a numerical value. The keyword, “Political Views” is also a demographic keyword type, but one that may be represented by a categorical value (e.g., 1=liberal, 2=conservative, 3=independent, etc.). The entry “Top 5000 Favorite Movies” in the Keyword Names column represents 5000 different keywords each associated with one of 5000 different movie titles, respectively. For example, the movie title “Gone with the Wind” may be a keyword. Each of the 5000 keywords is an Interest keyword and is represented by a binary value in the illustrated embodiment to indicate that the movie title occurs or does not occur in the profile of a user 102. While Demographic and Interest keyword types are illustrated in Table 1, other keyword types (e.g., contacts, skills, etc.) may also be included.

TABLE 1
Keywords

| | | Keyword |
|---|---|---|
| Keyword Names | Keyword Type | Value |
| Gender | Demographic | Categorical |
| Birth Year | Demographic | Numerical |
| Political Views | Demographic | Categorical |
| Relationship Status | Demographic | Categorical |
| User Type | Demographic | Categorical |
| Top 5000 Favorite Movies | Interests | 5000 Binary |
| Top 5000 Favorite Books | Interest | 5000 Binary |
| Top 5000 Favorite Music | Interest | 5000 Binary |
| Top 5000 Favorite Activities | Interest | 5000 Binary |
| Top 5000 Favorite TV shows | Interest | 5000 Binary |

The profile for each user 102A-102N may be represented as a vector and each keyword that occurs in the profile may be represented as a dimension or an element of the vector. Dimensions may include entries other than keywords and some keywords may not be represented by a dimension. In some embodiments, dimensions may represent multiple keywords. Each dimension may include a numerical value, a binary value, or a categorical value. In various embodiments, a numerical value may represent the number of occurrences of a particular keyword in the profile of the user 102, an age of the user 102, income, the number of friends of the user 102, etc. A binary value may represent at least one occurrence (e.g., “1”) or non-occurrence (e.g., “0”) of the keyword in the profile of the user 102. A categorical value may represent a political view, gender, religion, etc. A profile database containing all the keywords for all the users 102 may include as many as 10,000 to 100,000 or more keywords i.e., dimensions. On the other hand, a reduced set of keywords (discussed below) may include many fewer keywords, for example 100 to 200 keywords. In some embodiments, the profile database 200 and/or the social network provider 130 includes a reduced set of keywords.

The invitation module 210 is configured to send an invitation to users 102A-102N of the social network environment 100 and receive responses to the invitation from the users 102A-102N. In various embodiments, the invitation module 210 may send invitations and receive responses from pilot users 102A and/or target users 102B. Examples of an invitation include an advertisement, a survey, a request to provide information to the social network provider 130, a request to send information to another user 102, a suggestion to form a group, a request to join a group, a request to confirm a photo tag, an offer to purchase a real, digital, or virtual asset, and so on. In some embodiments, an invitation may include an opportunity for the user to respond by taking an action.

In various embodiments, a response includes accepting the invitation by clicking on a link within the invitation, rejecting the invitation, requesting more information about the invitation, requesting to be reminded later of the invitation, and so forth. In some embodiments, ignoring the invitation may be a default response. A positive response may include clicking on a button associated with the invitation. Clicking on a link in an invitation is known as a “click through.” Examples of a “click through” response include clicking on a link to purchase a product, view a webpage, download information, and upload information. A click-through rate may be calculated by dividing a number of “click-through” responses by a number of users who received the invitation. A response may further include taking other actions, such as joining a group, posting a photo, tagging a photo, answering a survey, forwarding a message, forming a group, posting a blog, and so forth.

The invitation module 210 may be configured to receive responses for a predetermined period of time. For example, the invitation module 210 may send an invitation to 50,000 pilot users 102A and receive responses to the invitation via the invitation module 210 for one hour. In some embodiments, the invitation module 210 may receive a predetermined number of responses. For example, the invitation module 210 may send an invitation to 50,000 pilot users 102A and stop accepting responses after receiving the first 10,000 responses.

The pilot group module 220 is configured to select the pilot users 102A from the users 102 and provide a list of the pilot users 102A to the invitation module 210. The pilot group module 220 may randomly select the pilot users 102A from all of the users 102 or from a subset of the users 102. Alternatively, the pilot group module 220 may select pilot users 102A based on various criteria, for example, age, gender, location, and so on.

The pilot group module 220 is further configured to receive the responses from the invitation module 210. The pilot group module 220 may provide the invitation module 210 with a time period for accepting responses from the pilot users 102A. Alternatively, the pilot group module 220 may direct the invitation module 210 to receive a predetermined number of responses from the pilot users 102A. For example, the pilot group module 220 may provide the invitation module with directions to accept only the first 10,000 responses.

In some embodiments, the pilot group module 220 may subdivide the pilot group into a plurality of subgroups randomly or according to one or more characteristics of the pilot users 102A. For example, a pilot group of about 50,000 pilot users 102A may be subdivided into 10 subgroups of about 5,000 pilot users 102A based on some characteristic or combination of characteristics, for example, geographical region, age bracket, occupation, membership in a social group, and so on. The pilot group module 220 may count the number of pilot users 102A who respond positively in each of the 10 separate segmented communities and direct the invitation module 210 to send the invitation to all of the users 102 in the network who share the characteristics of the pilot group that had the highest number of positive responses. Alternatively, the pilot group module 220 may divide the social network community 100 into subgroups based on characteristics of the users 102 and select a plurality of pilot users 102A at random from each of the subgroups. For example, 10 separate segmented communities may be selected from the social network community 100 and the pilot group module 220 may select 5,000 pilot users 102A at random from each of the segmented communities. The positive responses may be counted as above for each of the 10 separate segmented communities. This may save computation time in generating new probability functions for related invitations.

The dimension reduction module 230 is configured to reduce the number of keywords (i.e., dimensions) used in the profiles associated with the pilot group. The number of different keywords in the various profiles for all the users 102 can result in a very large set of keywords before dimension reduction. For example, a total of about 10,000 to 100,000 keywords might be found in the profiles for all or a large number of the users 102. Thus, 10,000 to 100,000 keywords may be available for correlation with responses. The memory space and computing resources required to process correlations with such a large number of keywords can be very large.

The dimension reduction module 230 reduces the 10,000 to 100,000 keywords to a reduced set of, for example, about 100 to 200 keywords using dimensional reduction techniques that are known in the art. The reduced keyword set may be based on the keywords collectively found in the profiles associated with the group of pilot users 102A. A simple, intuitive example of a keyword reduction technique includes keeping all the keywords found in all the profiles of the pilot group and discarding all keywords not found in their profiles. However, the number of remaining keywords might be to numerous. Techniques that may be useful for reducing the number of dimensions while minimizing information loss include singular vector decomposition (SVD), probabilistic latent semantic indexing (PLSI), linear discriminant analysis (LDA), feature selection, and so forth. The keyword reduction may be performed before or after sending the invitation to the pilot users 102A. In some embodiments, keyword reduction may produce new keywords that are based on combinations of keywords in the data set before reduction. For example, the keyword reduction module 230 may group several movie keywords (e.g., “spider man 1,” “spider man 2,” and “spider man 3”) into one reduced keyword “spider man” representing spider man in general.

The training set module 240 is configured to classify the responses, correlate the classified response from each pilot user 102A with keywords in the profile database 200 for the pilot user 102A, and create a training set of data pairs from the correlations. In some embodiments, the training set may not include data pairs from all of the pilot users 102A and the training set module 240 may select the pilot users 102A to be included the training set as discussed below.

The training set module 240 may classify each response for each pilot user 102A. Classification of a response includes determining if a response is a positive response or negative response. For example, the responses from the pilot users 102A may include clicking on the invitation (a positive response) or taking no action (a negative response). In various embodiments, positive responses include accepting an invitation by clicking on a link within the invitation, requesting more information about the invitation, requesting to be reminded later about the invitation, joining a group, posting a photo, tagging a photo, and so forth. Negative responses may include affirmatively rejecting the invitation (e.g., clicking on a “no” button), ignoring the invitation, abstaining from responding, and so forth. In some embodiments, classification includes assigning a value of “1” to a positive response and a value of “0” to a negative response. The training set module 240 may store the classifications (“1” or “0”) in the profile database with the profile information associated with the respective pilot users 102A.

The training set includes correlated pairs of data, each data pair representing a classified response and a profile of a pilot user 102A. The data pairs may be represented as vector pairs. Each vector pair may include a response vector representing a classified response by a pilot user 102A and a keyword vector representing keywords in the profile of the pilot user 102A. Each response vector may include a binary value as discussed above. Each keyword vector may include numerical, binary, or categorical values. For simplicity, only binary values are discussed below, thus, each dimension representing a keyword in the vector includes a “1” or “0” representing an occurrence or non-occurrence, respectively, of the keyword. However, in general, dimensions including numerical and/or categorical values may also be included in the training set vectors.

In a simplified example, the reduced keyword set includes three keywords, namely (“Beatles,” “hockey,” “Murasaki”) and the training set includes a first pilot user 102A and second pilot user 102A. A user profile for the first pilot user 102A may include the keywords (“Shakespeare,” “Beatles,” “hockey,” “orange,” “stargazing”) and the keyword vector may be represented by a (1,1,0). The first pilot user 102A responds positively to an invitation for a football video and a “1” is entered in the training set response vector for the first pilot user 102A to indicate the positive response. Thus, the training set vector pair for the first pilot user 102A is (1), (1,1,0) representing: (response=1), (“Beatles”=1, “hockey”=1, “Murasaki”=0). The user profile for the second pilot user 102A may include the keywords (“Beatles,” “red hot chili peppers,” “pencil,” “a bridge too far,” “carpet cleaning,” “rose”). The second pilot user 102A responds negatively to an invitation for the football video and a “0” is entered to indicate the negative response. Thus, the training set vector pair for the second pilot user 102A is (0), (1,0,0) representing: (response=0), (“Beatles”=1, “hockey”=0, “Murasaki”=0). This example is merely illustrative and the training set module 240 generally uses more complex methods known in the art for selecting keywords from the reduced keyword set for the keyword vector and correlating the response vector with the keyword vector. For example, some keywords common to both the reduced keyword set and a profile may not be represented in the keyword vector while some keywords not in common may be represented.

The training set may include vector pairs for all the pilot users 102A. Generally, the number of pilot users 102A who respond positively is much less than the number of pilot users 102A who respond negatively. In some embodiments, the training set module 240 may assign relative weights to the positive and/or negative pairs in the training set. The weights may be selected according to various weighting schemes. In some embodiments, the relative weights of the positive and negative response may be selected to make the sum of the weighted positive pairs about equal to the sum of the weighted negative pairs. For example, if a pilot group returns 10,000 positive responses and 50,000 negative responses, the training set module 240 may assign a weight to the vector pairs in the positive responses that is five times the weight assigned to the vector pairs in the negative responses. Other weighting schemes may be applied to the vector pairs in the training set.

In some embodiments, the training set module 240 is configured to select a subset of the pilot users 102A to be included the training set. For example, the training set module 240 may stratify the pilot users into two groups of pilot users 102A based on whether the response vectors are positive or negative and include entries for all pilot users 102A who have responded positively and a random selection of about an equal number of entries for pilot users 102A who have responded negatively. When the training set is still too large, the training set module may select a smaller number of pilot users 102A randomly in about equal numbers from each of the two stratified groups.

The probability function module 250 is configured to generate a probability function based on the training set. The probability function module 250 may use the probability function to predict the likelihood that a user will respond positively (or negatively) to the invitation. In various embodiments the probability function module 250 generates the probability function using a supervised learning procedure, or a machine learning technique such as a support vector machine (SVM), a neural network, or a boosted tree procedure. Boosted tree procedures may be used because boosted trees do not require normalization of attributes and output may be used to interpret results. More information about the probability function and supervised learning procedures is contained in a paper entitled “Personalization for Online Social Networks” by Yun-Fang Juan, et al., presently unpublished and attached hereto as an appendix.

The probability function module 250 is further configured to select target users 102B to receive the invitation. The target users 102B may be selected from all the users 102 of the social network environment 100. For example, the probability function module 250 may rank all the users 102 from highest to lowest according to a calculated likelihood of responding positively to the invitation and select the 500,000 highest ranked users 102 to become target users 102B. In some embodiments, the target users 102B may be selected from less than all the users 102. For example, the probability function module 250 may rank a fraction of the users 102 and select target users 102B as above. Alternatively, the probability function module 250 may select target users 102B for whom the calculated likelihood of responding positively to an invitation exceeds a predetermined threshold value. The probability function module 250 may adjust the predetermined threshold value to select fewer or more target users 102B.

In some embodiments, a similar invitation may be sent to the selected target users 102B. A similar invitation may be any invitation that contains a similar content, message, or function as the invitation sent to the pilot users 102A. For example, an invitation to enter a blog about surfing may be similar to an invitation in the form of an advertisement to purchase snorkeling equipment via the social network provider 130 since both invitations relate to ocean sports.

The invitation module 210 may track the number of target users 102B who receive the invitation, the positive and negative responses to the invitation sent to the target users 102B, and/or the click-through rate. The response data tracked by the invitation module 210 may be used to perform keyword extraction. Please see co-pending U.S. patent application Ser. No. ______ filed on Aug. 16, 2007, Attorney Docket No. PA4140US entitled “System and Method for Keyword Selection in a Web-Based Social Network,” incorporated herein by reference.

While a response to an invitation is used as one type of response variable entered in the training set vectors, other types of response variables may be used to help segment the users 102 and allow vendors to target users 102. For example, a response variable may include a frequency of usage of a user interface element of the social network environment 100. Examples of such usage include number of blog posts, number of mobile photo uploads, etc. In some embodiments, the response variable may include a click through rate of a content element. A position of the content may be provided as a dimension to the training set module 240 and/or dimension reduction module 230 to account for positional effects. Group membership may be used as the response variable. For example, a response variable may have value of “1” if a user is a member of the interested group and “0” otherwise.

Although the invitation engine 140 is described as being comprised of various components (the profile database 200, the invitation module 210, the pilot group module 220, the dimension reduction module 230, the training set module 240, and the probability function module 250), fewer or more components may comprise the invitation engine 140 and still fall within the scope of various embodiments.

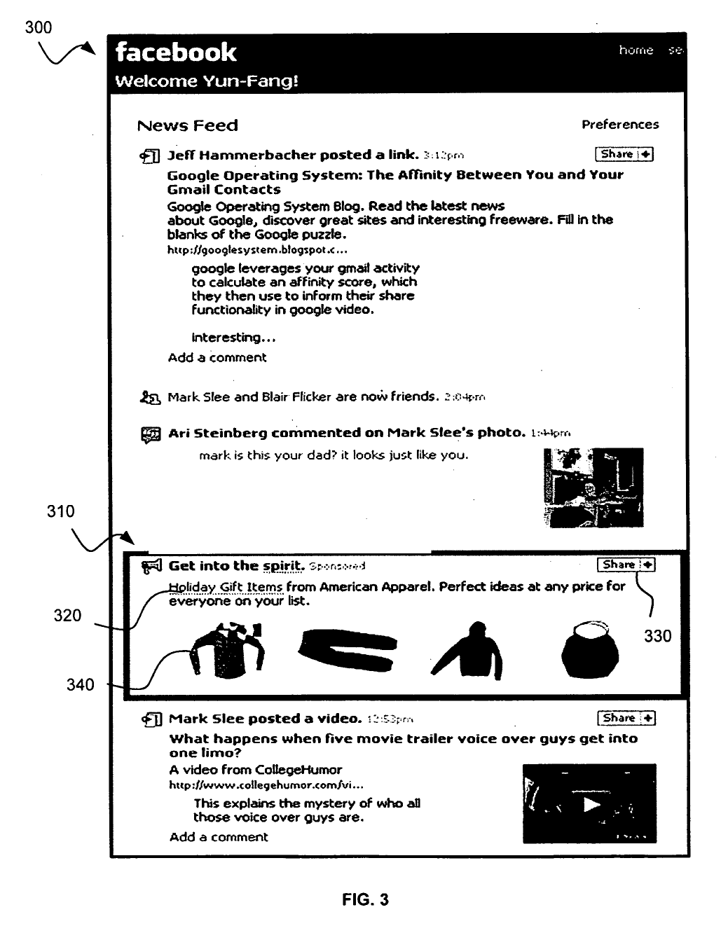

FIG. 3 is a screen shot illustrating an example of an invitation 310 embedded into a news feed 300 for a user 102. A news feed presents information about friends of a user 102 in a social network environment 100. The invitation 310 is contained in the form of a feed advertisement in the news feed 300 and includes links 320, 330, and 340. The link 320 is configured to direct the user 102 to a web based gift store. The link 330 is configured to enable the user 102 to forward or share the invitation 310 with another user 102 in the social network environment 100. The link 340 uses one or more clothing icons to direct the user 102 to particular pages within a web based gift store.

The invitation module 210 may embed the invitation 310 into a news feed 300 directed to pilot users 102A and monitor pilot users 102A for positive and negative responses to the invitation 310. For example, a positive response may include clicking on one or more of the links 320, 330 and 340. The invitation module 210 may send the same invitation 310 to target users 102B who are selected based on a probability function determined from results of the responses from pilot users 102A.

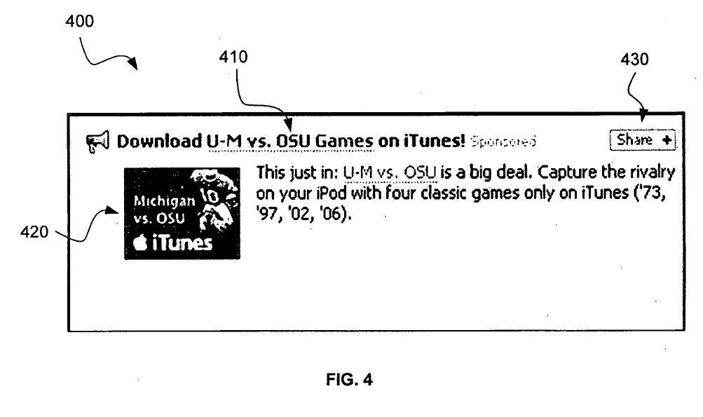

FIG. 4 is an illustration of an exemplary iPod download invitation 400 according to one embodiment. The iPod download invitation 400 contains download links 410 and 420, and share link 430. When selected, the download links 410 and 420 download a football game or information about the football game to the iPod. The share link 430 enables the user 102 to forward the invitation 400 to another user 102 of the social network. The invitation module 210 may embed the iPod download invitation 400 into a news feed 300 directed to pilot users 102A. The invitation module 210 may monitor the pilot users 102A for positive or negative responses. For example, the response to the iPod download invitation 400 may be considered positive if pilot user 102A clicks the share link 430 sending the iPod download invitation 400 to an acquaintance (another user 102) who selects the download link 410 or 420. In some embodiments, the training set may include profile information from users 102 who were not part of the pilot group, but responded positively to the iPod download invitation 400 that was received via the share link 430 from a pilot user 102A. The invitation module 210 may send the same iPod download invitation 400 to target users 102B who are selected based on a probability function determined from results of the responses of the pilot users 102A to the iPod download invitation 400.

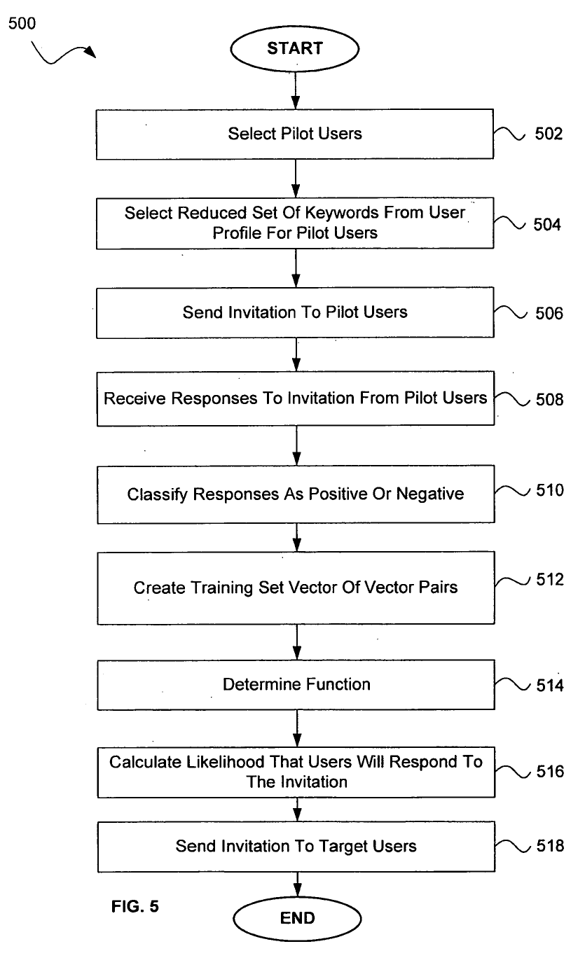

FIG. 5 is a flow chart of an exemplary method 500 for selecting users of a web-based social network who are likely to respond to an invitation, each of the users having associated profile information. In step 502, a plurality of pilot users are selected from the users of the web based social network. In step 504, a reduced set of keywords is selected from the profile information of the pilot users.

In step 506, an invitation is sent to each of the pilot users. In step 508, responses are received from pilot users. In step 510, the received responses are classified as either positive or negative.

In step 512, a training set of vector pairs is created. Each of the vector pairs represents a pilot user and includes data representing the classified response received from the pilot user and a set of training keywords selected from the reduced set of keywords and based at least in part on the associated profile information for the pilot user.

In step 514, a function is determined based on the training set of vectors. In step 516, the function is used to calculate a likelihood that one or more of the users in the web based social network will respond to the invitation. In some embodiments, the likelihood of accepting the invitation is determined for every user of the social network.

In optional step 518, an invitation is sent to one or more target users who are selected to receive the invitation based on the calculated likelihood of responding.

While the method 500 is described as being comprised of various steps fewer or more steps may comprise the process and still fall within the scope of various embodiments. In some embodiments, the order of the steps of the method 500 may be varied and still fall within the scope the various embodiments. For example, the step 504 of selecting a reduced set of keywords may be performed before or after the steps 506, 508, 510.

The embodiments discussed herein are illustrative of the present invention. As these embodiments of the present invention are described with reference to illustrations, various modifications or adaptations of the methods and/or specific structures described may become apparent to those skilled in the art. All such modifications, adaptions, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method for selecting users of a web-based social network who are likely to respond to an invitation, each of the users having associated profile information, the method comprising:
selecting a plurality of pilot users from the users in the web based social network;
selecting a reduced set of keywords from the profile information for the pilot users;
sending the invitation to the pilot users;
receiving responses to the invitation from the pilot users;
classifying the received responses as either positive or negative;
creating a training set of vector pairs, each vector pair representing a pilot user and including data representing the classified response received from the pilot user and a set of training keywords selected from the reduced set of keywords and based at least in part on the associated profile information for the pilot user;
determining a function based on the training set of vector pairs that calculates from a user's profile information a likelihood that the user will respond to the invitation; and
calculating from the function a likelihood that each of one or more of the users in the web based social network will respond to the invitation.

2. The method of claim 1, further comprising ranking the one or more users based on the calculated likelihood of each user responding and sending the invitation to a predetermined number of users having the highest calculated likelihood of responding.

3. The method of claim 1, further comprising sending the invitation to users having a calculated likelihood of responding that is higher than a threshold value.

4. The method of claim 1, wherein selecting a plurality of pilot users comprises randomly selecting a predetermined number of pilot users from the users of the web based social network.

5. The method of claim 1, wherein selecting a reduced set of keywords comprises using singular vector decomposition (SVD).

6. The method of claim 1, wherein selecting a reduced set of keywords comprises using latent dirichlet allocation.

7. The method of claim 1, wherein selecting a reduced set of keywords comprises using probabilistic latent semantic indexing (PLSI).

8. The method of claim 1, wherein selecting a reduced set of keywords comprises using feature selection.

9. The method of claim 1, wherein determining a function based on the training set of vector pairs comprises using a boosted trees method.

10. The method of claim 1, wherein determining a function based on the training set of vector pairs comprises using support vector machine (SVM) analysis.

11. The method of claim 1, wherein determining a function based on the training set of vector pairs comprises using neural network analysis.

12. The method of claim 1, wherein classifying the received responses comprises classifying the received responses as positive if the user clicks on the invitation.

13. The method of claim 1, wherein classifying the received responses comprises classifying the received responses as positive if the user requests information about the invitation.

14. The method of claim 1, wherein classifying the received responses comprises classifying the received responses as positive if the user makes a purchase.

15. The method of claim 1, wherein classifying the received responses comprises classifying the received response as negative if the user does not respond to the invitation within a certain time.

16. The method of claim 1, wherein creating a training set of vectors for one or more pilot users further comprises:
stratifying the pilot users based on classified responses; and
randomly sampling the stratified pilot users.

17. The method of claim 1, wherein creating a training set of vector pairs further comprises:
selecting a first set of pilot users;
selecting a second set of pilot users;
determining a scalar based on a number of pilot users in the first set and a number of pilot users in the second set; and
multiplying each vector pair representing pilot users in the first set by the scalar.

18. The method of claim 17, wherein the scalar is about equal to a number of pilot users in the second set divided by a number of pilot users in the first set.

19. The method of claim 17, wherein the first set of pilot users is selected from pilot users providing a positive response and the second set of pilot users is selected from pilot users providing a negative response.

20. The method of claim 17, wherein the first set of pilot users is selected from pilot users providing a positive response and the second set of pilot users is selected from a random sample of all pilot users.

21. The method of claim 17, wherein the first set of pilot users is selected from pilot users providing a positive response and the second set of pilot users is selected from a random sample of pilot users providing a negative response.

22. The method of claim 1, wherein sending the invitation to a pilot user comprises embedding the invitation into a personal web page.
